(19) United States
(12) Patent Application Publication
(10) Pub. No.: US 2025/0383968 A1
(43) Pub. Date: Dec. 18, 2025

(54) MULTIPLE ACCESS TRACKERS FOR A MEMORY DEVICE

(71) Applicant: Micron Technology, Inc., Boise, ID (US)

(72) Inventors: Danilo CARACCIO, Milano (IT); Alessandro ORLANDO, Milano (IT); Massimiliano TURCONI, Gorgonzola (IT)

(21) Appl. No.: 19/182,104

(22) Filed: Apr. 17, 2025

Related U.S. Application Data
(60) Provisional application No. 63/659,203, filed on Jun. 12, 2024.

(51) Int. Cl. G06F 11/30

(52) U.S. Cl. CPC G06F 11/3037; G06F 11/3093

(57) ABSTRACT

In some implementations, a memory device may configure multiple access trackers to track accesses to a memory, including a counting bloom filter access tracker associated with a first memory address range, a cache-based tracker access tracker associated with a second memory address range, and a sorted look-up table access tracker associated with a third memory address range. The memory device may receive an access request indicating a memory address to be accessed and may determine that the memory address is within at least one of the first, second, or third memory address range. The memory device may determine one or more unit identifiers associated with the memory address, may identify one or more access trackers that are associated with the one or more unit identifiers, and may update one or more counters associated with the one or more access trackers, accordingly.

### CROSS-REFERENCE TO RELATED APPLICATION

This patent application claims priority to U.S. Provisional Patent Application No. 63/659,203, filed on Jun. 12, 2024, entitled “MULTIPLE ACCESS TRACKERS FOR A MEMORY DEVICE,” and assigned to the assignee hereof. The disclosure of the prior application is considered part of and is incorporated by reference into this patent application.

### TECHNICAL FIELD

The present disclosure generally relates to memory devices, memory device operations, and, for example, to multiple access trackers for a memory device.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory device and/or may include a CXL interface. CXL technology contributes to the progression of memory systems in computing environments. Effective operation of these systems involves techniques that consider memory usage characteristics.

### BRIEF DESCRIPTION OF THE DRAWINGS

FIG. 1 is a diagram illustrating an example system capable of enabling multiple access trackers for a memory device.

FIG. 2 is a diagram illustrating another example system enabling multiple access trackers for a memory device.

FIGS. 3A-3F are diagrams of example implementations associated with multiple access trackers for a memory device.

FIG. 4 is a flowchart of an example method associated with multiple access trackers for a memory device.

### DETAILED DESCRIPTION

In modern computing, facilitating efficient access to and usage of memory resources is a critical aspect of overall system performance, especially in the realm of CXL applications. CXL applications often require tracking of memory request patterns through mechanisms referred to as hotness trackers (sometimes referred to herein as access trackers and/or CXL hotness monitoring units (CHMUs)), which identify and manage memory locations based on access frequency. This may be integral to applications such as memory tiering, which involves moving frequently accessed data to faster memory tiers for improved performance, and workload profiling, which assists in analyzing specific workload characteristics.

However, tracking and monitoring memory access frequency may present a range of technical challenges. Emerging standards (e.g., Open Compute Project (OCP) standards, CXL Consortium standards, and/or similar standards) may seek to streamline interfaces for hotness trackers. Accordingly, standardized interfaces may have to cope with varying access patterns, which may change dynamically and may not be uniformly distributed across a device's memory. This may result in a complex system that may need to be able to discern and act upon different access frequencies across non-uniform memory spaces, often requiring a capacity to concurrently execute multiple hotness tracker instances with diverse counting granularities, adding layers of tracking complexity.

Moreover, the need to concurrently configure multiple hotness trackers with different parameters, such as unit size and hotness threshold, imposes substantial demands on system resources. Configuring these trackers without overlap, or with the ability to track overlapping address ranges independently, may further increase system complexity. This may be even more prevalent in logical device fabric-attached memory (LD-FAM) devices, where the capability to activate multiple hotness trackers for each logical device may be required.

Accordingly, there exists a need for a solution that can accurately and efficiently monitor and track the varying hotness of memory addresses, adapting to changing workload patterns, with potentially overlapping address ranges, all while adhering to emerging industry standards and minimizing resource consumption. This may require integration into the CXL framework, enabling sophisticated memory access tracking to facilitate performance optimizations such as memory tiering and workload profiling.

Some implementations described herein include a memory device capable of efficiently managing access to a memory by determining memory hotness using multiple concurrent hotness tracking mechanisms. For example, the memory device may receive access requests indicating memory addresses and/or may utilize multiple access trackers (such as a counting bloom filter (CBF) access tracker, a cache-based tracker (CBT) access tracker, and/or a sorted look-up table (SLT) access tracker, among other examples) to monitor access frequency. In some implementations, the memory device may identify relevant unit identifiers based on the memory addresses, and/or the memory device may update the corresponding access trackers.

In some implementations, the memory device may be configured to receive (e.g., from a host device) configuration parameters for each access tracker, allowing for tailored memory monitoring. In this way, the memory device may be configured to accommodate different address ranges for each tracker, which can be either overlapping or non-overlapping. Furthermore, the memory device may maintain multiple hotlists (e.g., at least one for each access tracker), and/or may configure access thresholds to determine hot memory units for inclusion in the hotlists.

In this way, techniques described herein enable dynamic tracking of memory access hotness with a high degree of granularity and flexibility. By employing different tracking mechanisms, the techniques described herein may accommodate varying access patterns and/or may track overlapping address ranges independently, when required. Additionally, or alternatively, some techniques described herein enable a more effective memory hierarchy management through the employment of the multi-tracker approach that affords improved precision in identifying frequently accessed memory locations. This multi-tracker approach may lead to an optimization of memory tiering processes and workload profiling for CXL applications, among other examples. In doing so, the techniques described herein may enable data to be allocated in an optimal way to various memory tiers, reducing latency and enhancing memory subsystem performance. Additionally, or alternatively, the techniques described herein may lead to reduced costs, by enabling the use of lower-cost memories with higher access latency.

By utilizing multiple concurrent tracking mechanisms, the techniques described herein may conserve processing resources by selectively monitoring different segments of the memory with appropriately calibrated granularity, thus catering to workload-specific memory access patterns. Consequently, the techniques described herein may conserve memory resources by avoiding unnecessary duplication of tracking data and optimizing the allocation of static random access memory (SRAM) space. Moreover, the versatility in configuring multiple independent trackers may promote a more efficient and scalable adaptation to emerging memory technologies and industry standards, which in turn may mitigate the need for extensive reconfiguration or hardware changes, conserving resources related to system upgrade and maintenance. In this way, the techniques described herein conserve processing resources, memory resources, network resources, and/or the like, especially in complex and resource-intensive CXL ecosystems.

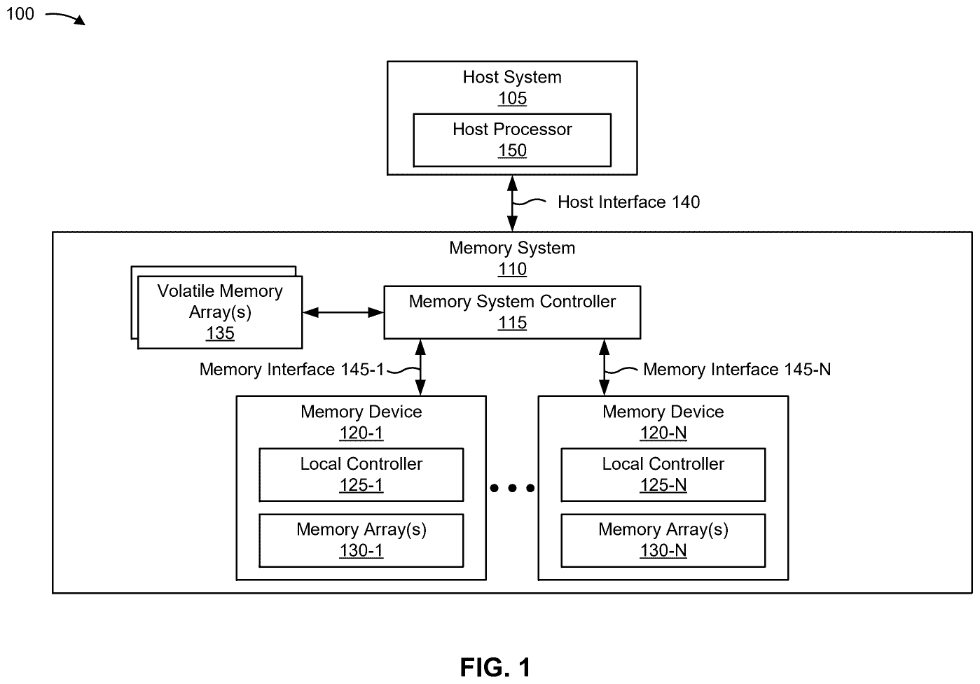

FIG. 1 is a diagram illustrating an example system 100 capable of enabling multiple access trackers for a memory device. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

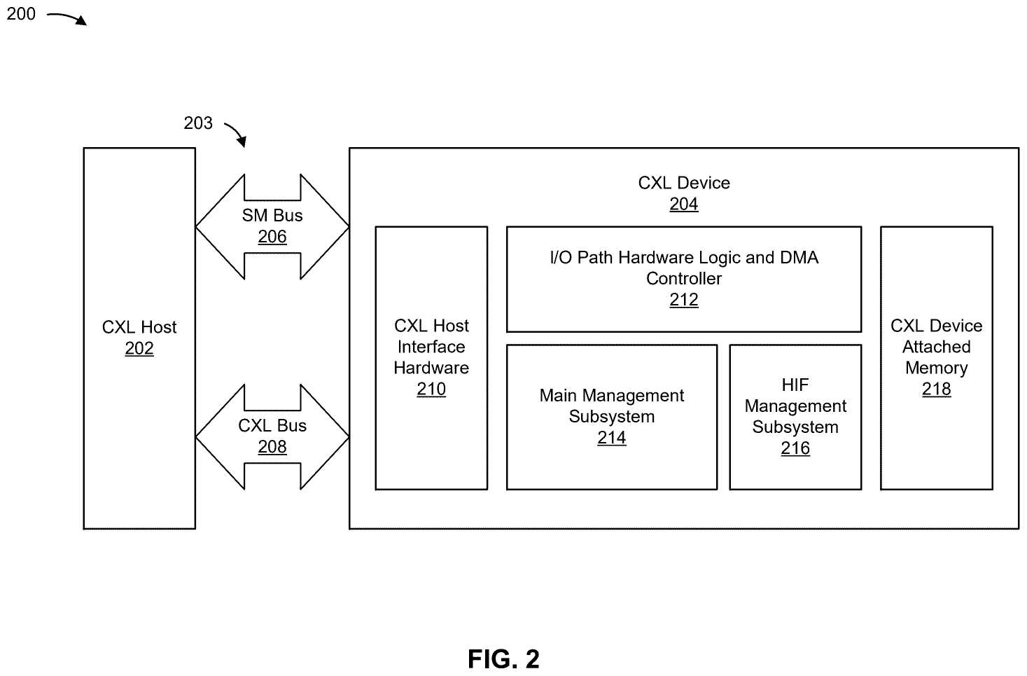

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host device, an access request indicating a memory address associated with a portion of a memory that is to be accessed, wherein the memory is associated with multiple access trackers including a CBF access tracker, a CBT access tracker, and an SLT access tracker; determine one or more unit identifiers associated with the memory address; identify one or more access trackers, of the multiple access trackers, that are associated with the one or more unit identifiers; and update one or more counters associated with the one or more access trackers.

In some implementations, one or more systems, devices, apparatuses, components, and/or controllers of FIG. 1 may be configured to configure multiple access trackers to track accesses to a memory, wherein the multiple access trackers include a CBF access tracker associated with a first memory address range, a CBT access tracker associated with a second memory address range, and an SLT access tracker associated with a third memory address range; receive, from a host device, an access request indicating a memory address associated with a portion of the memory that is to be accessed; determine that the memory address is within at least one of the first memory address range, the second memory address range, or the third memory address range; determine one or more unit identifiers associated with the memory address based on determining that the memory address is within the at least one of the first memory address range, the second memory address range, or the third memory address range; identify one or more access trackers, of the multiple access trackers, that are associated with the one or more unit identifiers; and update one or more counters associated with the one or more access trackers. In some implementations, the first memory address range, the second memory address range, and the third memory address range may be different memory address ranges. In some other implementations, at least two of the first memory address range, the second memory address range, or the third memory address range may at least partially overlap. Additionally, or alternatively, in some other implementations, at least two of the first memory address range, the second memory address range, or the third memory address range may be the same address range that is tracked by at least two of the multiple access trackers using varying granularities.

In some implementations, one or more systems, devices, apparatuses, components, and/or controllers of FIG. 1 may be configured to receive, from a host device, a CXL.memory request indicating a memory address associated with a portion of a DRAM that is to be accessed, wherein the DRAM is associated with multiple CHMUs including a CBF based CHMU, a CBT based CHMU, and an SLT based CHMU; determine one or more unit identifiers associated with the memory address; identify one or more CHMUs, of the multiple CHMUs, that are associated with the one or more unit identifiers; and update one or more counters associated with the one or more CHMUs.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 enabling multiple access trackers for a memory device. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL host, and a memory device, sometimes referred to as a CXL compliant memory device, a CXL memory device, or, more simply, a CXL device) and/or may be a CXL compliant system. In that regard, the system 200 may include a CXL host 202 (which may correspond to the host system 105) and a CXL device 204 (e.g., a CXL compliant memory system, which may correspond to the memory system 110). The CXL host 202 and the CXL device 204 may communicate via an interface 203 (e.g., host interface 140), which may include a system management (SM) bus 206 and/or a CXL bus 208 (e.g., a PCIe/CXL interface), among other examples.

In some examples, the CXL device 204 may be a CXL compliant memory system (sometimes referred to herein as a CXL memory system, a CXL memory device, a CXL memory module, a CXL device, and/or a similar term). A CXL compliant memory system may be a system that complies with the CXL standard and/or protocol, such as for a purpose of communicating with one or more host devices (e.g., CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL device 204 to CXL compliant host devices, such as the CXL host 202. In such examples, the PCIe/CXL interface may comply with CXL standard specifications for physical connectivity (e.g., a standard promulgated by the CXL Consortium), ensuring broad compatibility and ease of integration into existing systems using the CXL protocol. Additionally, or alternatively, the CXL device 204 may be designed to efficiently interface with computing systems (e.g., CXL host 202 and/or a host system 105) by leveraging the CXL protocol. For example, the CXL device 204 may be configured to utilize high-speed, low-latency interconnect capabilities of CXL, such as for a purpose of making the CXL device 204 suitable for high-performance computing, data center applications, artificial intelligence (AI) applications, and/or similar applications.

In some examples, the CXL device 204 may include a CXL memory controller (which may correspond to the memory system controller 115 and/or local controller 125), which may be an ASIC and/or which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL device 204 may further include and/or be associated with one or more high-bandwidth memory modules (HBMMs) or similar memory arrays (e.g., CXL device attached memory 218). For example, the CXL device 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL device 204 may include a power management unit, which may be configured to regulate power consumption associated with the CXL device 204 and/or which may be configured to improve energy efficiency for the CXL device 204. Additionally, or alternatively, the CXL device 204 may include additional components, such as one or more error correction code (ECC) engines, such as for a purpose of detecting and/or correcting data errors to ensure data integrity and/or improve the overall reliability of the CXL device 204. The CXL device 204 may be implemented using a combination of hardware and firmware blocks and/or components. In such examples, the firmware may execute on one or more embedded CPUs within the CXL device 204.

Additionally, or alternatively, the CXL device 204 and/or a CXL controller (e.g., an ASIC) of the CXL device 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL device 204 and one or more external devices, such as to the CXL host 202 via the SM bus 206 and/or the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL device 204 efficiently.

The I/O path hardware logic and DMA controller 212 may handle data transfers between the CXL device 204 and external devices, such as other memory modules and/or peripheral components. In some examples, a DMA controller portion of the I/O path hardware logic and DMA controller 212 may permit efficient data transfer without involving a CXL device 204 CPU, directly. Put another way, the DMA controller portion of the I/O path hardware logic and DMA controller 212 may manage data movement between the CXL device 204 and other system components, which may enhance overall system performance by offloading data transfer tasks from the CPU.

The main management subsystem 214 may serve as a central control and management unit within the CXL device 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL device 204 and/or may optimize performance of the CXL device 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL device 204 and/or the CXL host 202, such as by maintaining compatibility and/or reliability of the CXL link, among other examples.

In some examples, the CXL device 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

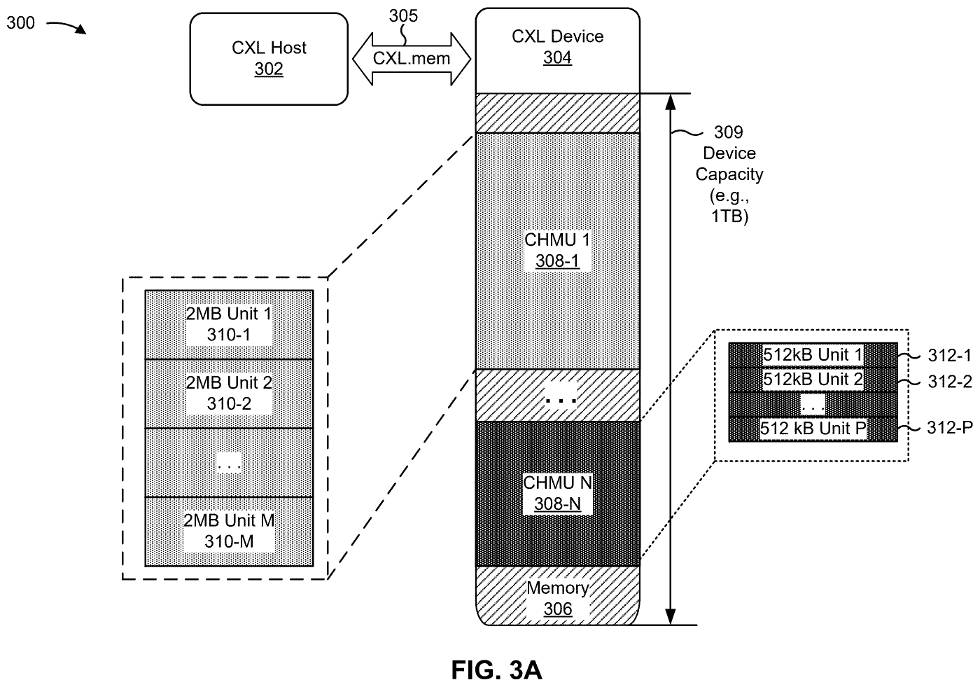

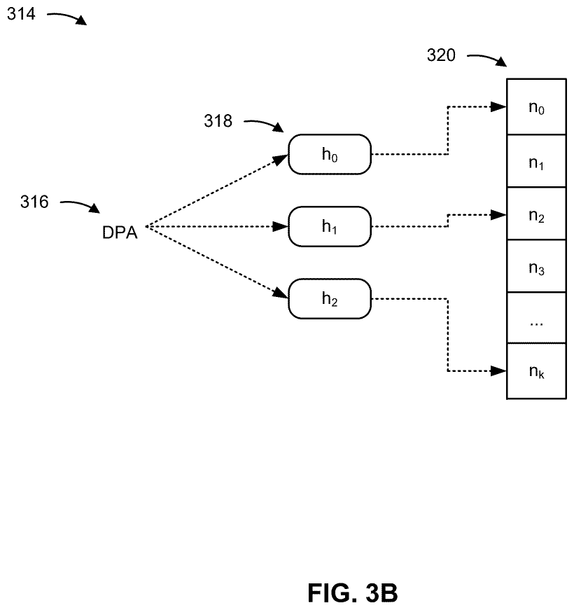

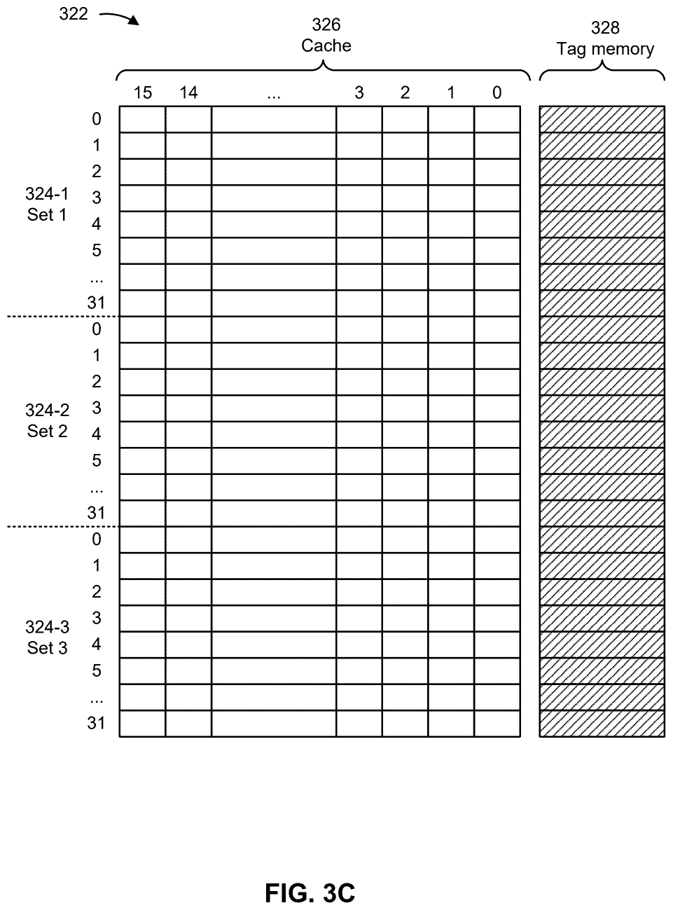

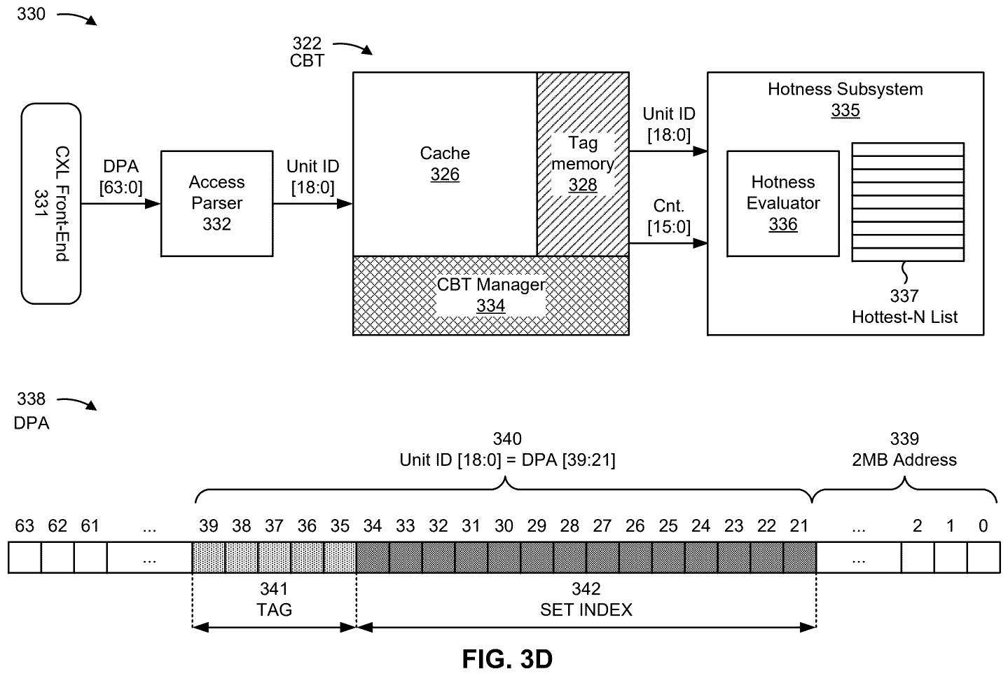

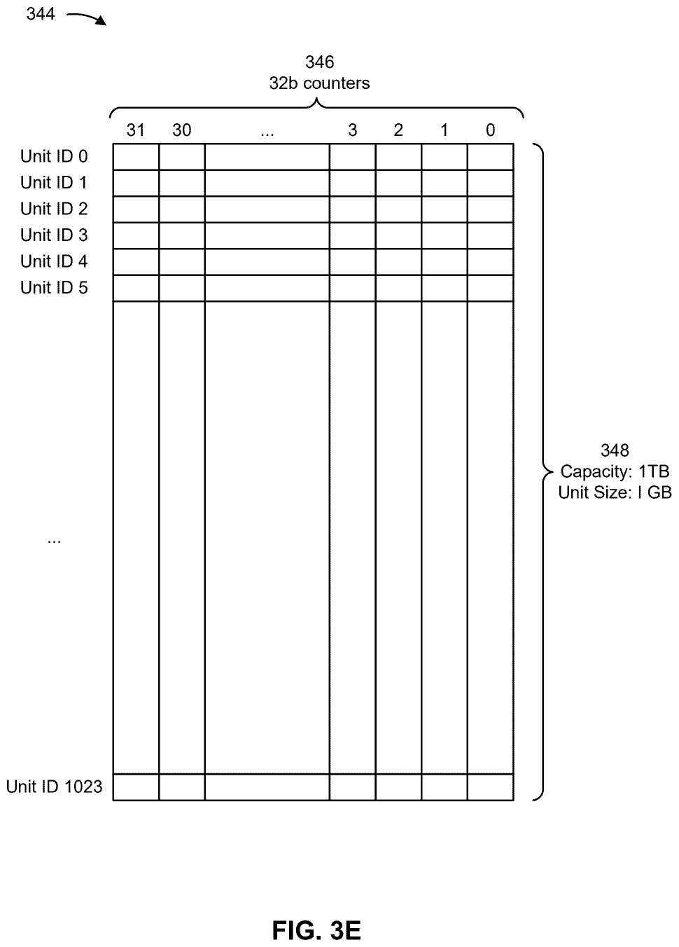

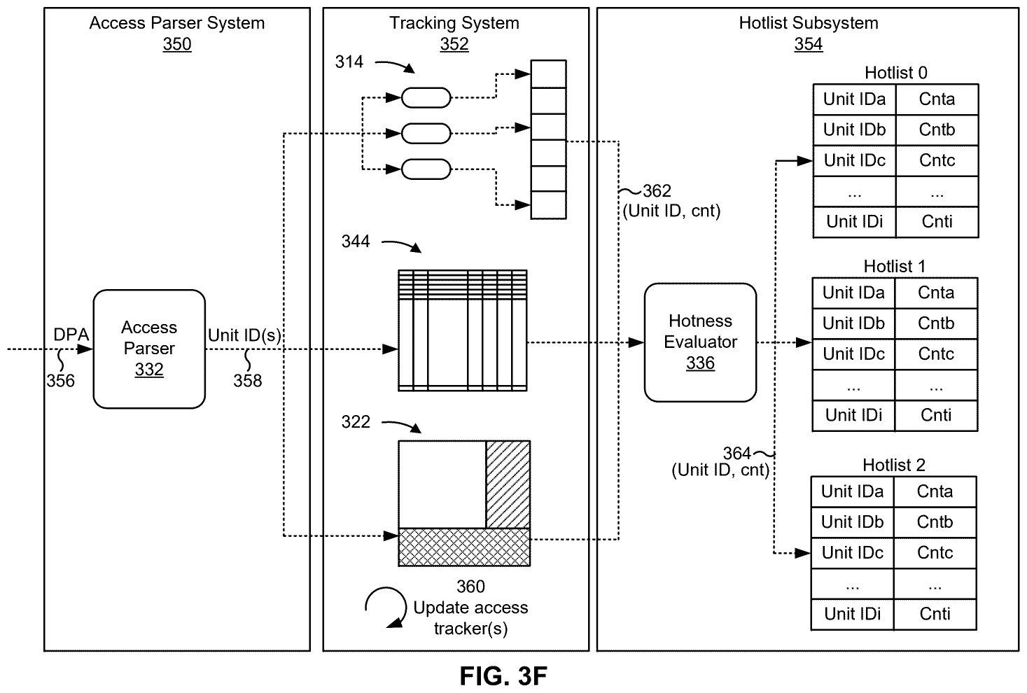

FIGS. 3A-3F are diagrams of example implementations associated with multiple access trackers for a memory device. The operations described in connection with FIGS. 3A-3F may be performed by the memory system 110, one or more components of the memory system 110 (such as the memory system controller 115, one or more memory devices 120, and/or one or more local controllers 125), the system 200, and/or or more components of the system 200 (such as the CXL device 204 and/or a CXL controller (e.g., ASIC) thereof, the main management subsystem 214, and/or another component of the system 200).

FIG. 3A shows an example of a system 300 in which a memory device may track accesses to a memory using multiple access trackers (e.g., multiple hotness trackers, such as multiple CHMUs). More particularly, in some implementations, a host system may communicate with a memory system by transmitting various types of requests and/or similar instructions between the host system and the memory system. More particularly, in the system 300, the host system is a CXL host 302 (e.g., CXL host 202) that communicates with an attached CXL device 304 (e.g., CXL device 204) using a CXL.mem protocol and/or via CXL.mem requests, as indicated by reference number 305. However, in some other implementations, the operations described in connection with FIG. 3A may be performed by a different type of host (e.g., a host system associated with a different type of interface, such as a non-CXL interface), a different type of attached memory system (e.g., a non-CXL device), and/or a different type of protocol (e.g., a non-CXL protocol), without departing from the scope of the disclosure.

In some implementations, the CXL device 304 may be a Type 3 CXL device, such as a memory expansion board, a persistent memory device, and/or a similar Type 3 CXL device used to provide a host system (e.g., the CXL host 302) with low-latency access to local DRAM and/or byte-addressable non-volatile storage, among other examples. Additionally, or alternatively, the CXL device 304 may be associated with a memory 306 (e.g., CXL device attached memory 218), which may include multiple DRAM components, among other examples. In some implementations, the CXL device 304 may be configured with multiple access trackers, such as by implementing multiple CHMUs 308 (shown in FIG. 3A as a first CHMU 308-1 through an N^{th} CHMU 308-N), which may be components of the CXL device 304 (e.g., components of a CXL ASIC) configured to track accesses to certain portions of the memory 306. Put another way, the CHMUs 308 may be components of the CXL device 304 that, once enabled, count in a specified timeframe (e.g., an epoch) a quantity of memory requests to a configured address range in the CXL device 304 (e.g., a Type 3 CXL device) and that identify hot units, which may be indicated to the CXL host 302 via one or more data structures (e.g., one or more hotlists and/or one or more hotness-N lists (HN-Ls)), which is described in more detail below. As used herein, a “hot unit” may be a memory unit that is accessed, during an epoch, with a frequency that satisfies a certain access threshold (sometimes referred to herein as a hotness threshold).

In some implementations, the CXL.mem requests indicated by reference number 305 may be associated with read and/or write operations at the CXL device 304. For example, in some implementations, a CXL.mem request may be a memory read (MemRd) request, which may be a request used by the CXL host 302 to read data from the memory 306 (e.g., DRAM memory and/or similar memory) of the CXL device 304. In such examples, a MemRd request may initiate a read operation to fetch data from a specific memory location at the CXL device 304. In some other implementations, a CXL.mem request may be a memory read data (MemRdData) request, which may be a response to a MemRd request. In such examples, the MemRdData request may carry, from the CXL device 304 to the CXL host 302, the actual data read from the memory 306. In some other implementations, a CXL.mem request may be a memory read with trusted execution environment (MemRdTEE) request, which may be similar to a MemRd request but which may be used specifically when accessing memory regions protected by a trusted execution environment (TEE). In some other implementations, a CXL.mem request may be a memory read data with TEE (MemRdDataTEE) request, which may be a response to a MemRdTEE request. In such examples, the MemRdDataTEE request may carry, from the CXL device 304 to the CXL host 302, the actual data read from a memory region protected by the TEE. In some other implementations, a CXL.mem request may be a memory speculative read (MemSpecRd) request, which may be a request used for speculative reads (e.g., reads in which the CXL host 302 anticipates requiring certain data before it is actually requested). In such examples, the MemSpecRd request may be used to prefetch data into caches or similar portions of memory, such as for a purpose of reducing latency when the data is later needed by the CXL host 302. In some other implementations, a CXL.mem request may be a memory speculative read with TEE (MemSpecRdTEE) request, which may be similar to a MemSpecRd request but which may be used specifically when accessing memory regions protected by a TEE.

In some other implementations, a CXL.mem request may be a memory write (MemWr) request, which may be a request used by the CXL host 302 to write data to the memory 306 of the CXL device 304. In such examples, a MemWr request may initiate a write operation, such as by providing the data to be written and a destination address for the data. In some other implementations, a CXL.mem request may be a memory write with partial (MemWrPtl) request, which may be a request used by the CXL host 302 when only a portion of the data in a memory location is being modified. In such examples, a MemWrPtl request may specify the data to be written and a byte mask indicating which bytes in the memory location should be updated. In some other implementations, a CXL.mem request may be a memory write with TEE (MemWrTEE) request, which may be similar to a MemWr request but which may be used specifically when writing to memory regions protected by a TEE. In some other implementations, a CXL.mem request may be a memory write with partial and TEE (MemWrPtlTEE) request, which may be similar to a MemWrPtl request but which may be used specifically when writing to memory regions protected by a TEE.

In some implementations, the CXL host 302 may be capable of configuring the CXL device 304 (more particularly, the CHMUs 308 of the CXL device 304) to track accesses (e.g., CXL.mem requests) to portions of the memory 306. In such implementations, the CXL host 302 (e.g., software running on the CXL host 302) may be able to determine a hotness of certain regions in a CXL-attached device (e.g., the CXL device 304) based on access patterns, among other examples. In that regard, based on configuration information received from the CXL host 302 and/or similar information, the CXL device 304 (more particularly, the CHMUs 308 of the CXL device 304) may count specified CXL.mem requests associated with portions of the memory 306, and/or the CXL device 304 may output a list or similar data structure indicating hot portions of the memory 306 and the related access counter values (which may or may not be ordered, such as in a descending order of access counter values). In some implementations, the CXL device 304 may count accesses within a configured monitoring period (e.g., epoch), may count accesses associated with multiple memory address ranges specified by the CXL host 302, and/or may count accesses using multiple access trackers (e.g., multiple CHMUs 308).

More particularly, in some examples, each CHMU 308 may be associated with one or more memory address ranges that are to be tracked by the corresponding CHMU 308. That is, the CXL host 202 may indicate one or more address ranges of the memory 306 to be monitored by each CHMU 308, such as a first set of one or more address ranges to be monitored by the first CHMU 308-1 through an N^{th} set of one or more address ranges to be monitored by the N^{th} CHMU 308-N. In some implementations, each address range may be associated with a contiguous set of device physical addresses (DPAs), with each DPA corresponding to a smallest portion of the memory 306 that is accessible by the CXL device 304. A set of address ranges configured for a given CHMU 308 may span an entire capacity of the memory 306 or may span a subset of memory locations across the device capacity. For example, as shown in connection with reference number 309, the CXL device 304 may be associated with a 1 terabyte (TB) capacity. Accordingly, in such examples, the set of address ranges configured for a given CHMU 308 may collectively be configured to monitor up to 1 TB of the memory 306.

Moreover, in some implementations the CHMUs 308 may be capable of counting accesses to the memory 306 (e.g., during a specified timeframe and/or epoch) at a corresponding memory unit granularity. The memory unit may correspond to a minimum memory size (e.g., 4 kilobytes (kB), 2 megabytes (MB), 1 gigabyte (GB), or 2 GB, among other examples) associated with a given CHMU 308, such that, using a given CHMU 308, the CXL device 304 may track, during an epoch, accesses to the memory units at the specified granularity. Accordingly, in some implementations, each CHMU 308 may be associated with one or more memory units, and/or a granularity of a memory unit associated with a given CHMU 308 may vary with respect to a granularity of a memory unit associated with other CHMUs 308. As shown in the system 300, the first CHMU 308-1 may be associated with M memory units, which may be associated with a first granularity, such as a 2 MB granularity. Accordingly, the memory units associated with the first CHMU 308-1 are shown in FIG. 3A as a first 2 MB unit 310-1 through an M^{th} 2 MB unit 310-M. Moreover, the N^{th} CHMU 308-N may be associated with P memory units (which may be the same quantity of memory units as are associated with the first CHMU 308-1, or which may be a different quantity of memory units than are associated with the first CHMU 308-1), which may be associated with a second granularity different from the first granularity, such as a 512 kB granularity. Accordingly, the memory units associated with the N^{th} CHMU 308-N are shown in FIG. 3A as a first 512 kB unit 312-1 through a P^{th} 512 KB unit 312-P.

In some implementations, as requests (e.g., CXL.mem requests) are received within a specified address range and/or as corresponding accesses are made within a specified address range, the CHMUs 308 may count accesses to memory units (e.g., the 2 MB units 310, the 512 KB units 312, among other examples) within the address range (e.g., using a hotness counter for each memory unit, sometimes referred to herein simply as a counter). In some implementations, each CHMU 308 of the CXL device 304 may be configured with a corresponding hotness threshold (sometimes referred to herein as an access threshold). The hotness threshold may be a value used to determine a hot memory unit, such that if a hotness counter of a memory unit satisfies the hotness threshold during an epoch, the memory unit may be identified as a hot unit and thus the corresponding unit identifier (ID) and/or hotness counter value may be added to a data structure, such as a hotlist. Put another way, the hotlist may be a data structure listing hot memory units (e.g., memory units accessed, during an epoch, with a frequency that satisfies the hotness threshold) along with their respective hotness counter values. In this regard, “epoch” may refer to a time interval with a configurable duration, which may be bound to a limit specified by the CXL device 304, during which hotness counters of accessed memory units are updated and/or during which the hotlist of accessed memory units that have satisfied a hotness threshold is populated. In some examples, each CHMU 308 may be associated with a corresponding hotlist, which is described in more detail below in connection with FIG. 3F.

In some implementations, one or more registers (e.g., small amounts of high-speed storage within the CXL device 304 used for temporary data storage and/or for facilitating communication between the CXL device 304 and other devices, such as the CXL host 302) may be used to indicate hotness monitoring capabilities of the CXL device 304 (more particularly, capabilities of the CHMUs 308 of the CXL device 304), to indicate configuration information associated with the CHMUs 308, and/or to transfer data associated with the CHMUs 308 (e.g., one or more instances of hotlists, among other examples). In some implementations, one or more registers used for conveying capability information, configuration information, and/or data may be referred to as access monitoring unit registers, hotness monitoring unit registers, and/or CHMU registers, among other examples.

In this way, the CXL device 304 may support multiple CHMU 308 instances running concurrently, with the CHMUs 308 being configured to track accesses to portions of the memory 306 at varying granularities. Put another way, the entire addressable space of the CXL device 304 (e.g., the range indicated by reference number 309) may not be uniform in terms of access frequency from different workloads, among other examples, and thus different access patterns may generate areas with different access frequency that may change over time. In order to accommodate the various access frequencies and/or to provide meaningful access tracking for the CXL host 302, the CXL device 304 may be capable of configuring multiple hotness trackers on overlapping or non-overlapping address ranges with different counting granularities (e.g., memory unit sizes) because some workloads may be tracked with larger unit sizes (e.g. 2 MB) to discover hotspots that could be tracked, afterwards, with a smaller granularity (e.g. 4 KB), among other examples. In this way, the multiple CHMUs 308 may be supported such that different parameters (e.g., unit size and/or hotness threshold, among other examples) may be configured for different portions of the memory 306 and/or such that various access trackers may operate concurrently. Additionally, or alternatively, in examples in which the CXL device 304 is an LD-FAM device, multiple CHMUs 308 may be activatable for each LD.

In some implementations, the multiple CHMUs 308 may support concurrent operation of a CBF access tracker, a CBT access tracker, and an SLT access tracker, among other examples. More particularly, FIG. 3B shows an example of a CBF access tracker 314 (sometimes referred to herein as a CBF based CHMU in the context of a CXL memory, such as in the context of the CXL device 304) that may be used to track accesses to certain portions of a memory (e.g., memory 306). The CBF access tracker 314 may be an access tracker that uses a probabilistic data structure to track accesses to a portion of a memory without managing associated addresses. More particularly, a CBF is a probabilistic solution that counts elements of a data stream. In the context of an access tracker, such as an access tracker associated with a CXL device, a CBF may be used to estimate an access frequency on a particular CXL.mem channel. In such implementations, as indicated by reference number 316, a DPA of an incoming memory request may be decoded and aligned to a memory unit size (e.g., 4 kB unit), such as for a purpose of deriving a unit ID associated with the memory request. Moreover, as indicated by reference number 318, the unit ID may be hashed into multiple hash functions to derive indexes in the CBF where counters (shown as no through nₖ in FIG. 3B, as indicated by reference number 320) are incremented. When a given counter achieves an access threshold (e.g., a threshold programmed by the host software), the corresponding memory unit may be classified as hot and may thus be added to a hotlist or similar data structure, which is described in more detail below in connection with FIG. 3F.

More particularly, the CBF-based access structure may implement a bloom filter, which is a space-efficient probabilistic data structure used to test whether an element is a member of a set. In some implementations, the bloom filter may work by hashing elements into a bit array, with multiple hash functions being used to map elements to several bits in the array. A CBF may associate a counter with each bit (rather than a simple binary value, 0 or 1), with the counter keeping track of a quantity of times that an element has been hashed to that specific bit position. In that regard, when the memory device accesses a memory location, an address of the memory location may be hashed using multiple hash functions, with the resulting hash values being used to index the CBF. Moreover, counters associated with the corresponding bits in the CBF may be incremented. Over time (e.g., over an epoch), as accesses to different memory regions occur, the counters associated with the bits in the CBF may reflect a frequency of access to each region. In some implementations, each of the elements in the CBF may correspond to a set of overlapping blocks of memory (e.g., each of the elements may indicate a quantity of accesses associated with partially overlapping subsets of addresses). Accordingly, a minimum value of the multiple elements associated with a given address may indicate a highest quantity of accesses that may have been performed on a given address. Accordingly, in such implementations, the memory device may determine whether a minimum value of the multiple elements associated with a given memory unit satisfies an access threshold, and, if so, may add the memory unit to a corresponding hotlist.

As shown in FIG. 3C, in some implementations a CBT access tracker 322 (sometimes referred to herein as a CBT based CHMU in the context of a CXL memory, such as in the context of the CXL device 304) may be used to track accesses to certain portions of the memory 306. A CBT access tracker 322 may use a set-associative structure for implementing a CHMU 308. Functionally, the CBT access tracker 322 may track CXL.mem accesses on a certain quantity of memory units. For example, for a given CXL.mem request received from a host device, the memory device may align a DPA associated with the CXL.mem request with a unit ID, may determine a set 324 (shown in FIG. 3C as a first set 324-1 through a third set 324-3) associated with the unit ID, and/or may increment a cache line in a cache 326 (e.g., within the corresponding set 324 of the cache 326) associated with the unit ID. For example, in the example shown in FIG. 3C, each set 324 may be associated with 32 cache lines (indexed as 0 through 31 in FIG. 3C), each including a 16-bit counter (with the bit positions indexed as 0 through 15 in FIG. 3C). Additionally, each cache line may be associated with a portion of a tag memory 328 that stores an identifier (e.g., a unit ID and/or a portion thereof, sometimes referred to herein simply as a tag) associated with the given cache line. In this way, the CBT access tracker 322 may operate in a similar manner to a memory-side cache in terms of address mapping on the cache lines; however, unlike a memory-side cache, with the CBT access tracker 322 there is no need to transfer data to a backing storage, pre-fetch data, and/or synchronize data on a backing storage.

In response to receiving a CXL.mem request associated with a certain DPA, the memory device may map the DPA to a unit ID, locate (e.g., using the tag memory 328) a cache line associated with the unit ID being accessed, and/or update (e.g., increment) a counter stored in the cache line (e.g., stored using the 16-bit counter associated with the cache line). In implementations in which there is no cache line in the corresponding set 324 associated with the given unit ID (e.g., in implementations in which the tag memory 328 does not include a tag match), the memory device may evict another cache line (e.g., using a first-in, first-out (FIFO) policy, a least recently used (LRU) policy, a random policy, or some other policy) and thus add a cache line associated with the unit ID to begin tracking accesses to that unit ID. Put another way, in some implementations, the CBT access tracker 322 may implement an eviction mechanism (with a related eviction policy) to free space when a set 324 is full and a new address needs to be counted. In that regard, the CBT access tracker 322 may result in an estimation of hotness and/or may be affected by inaccuracy and loss of information (e.g., due to the set-associative structure tracking less than all unit IDs at any given time).

FIG. 3D shows an example 330 of tracking memory accesses using the CBT access tracker 322 (e.g., using a CBT based CHMU). In some implementations, the CBT access tracker 322 may track accesses during an epoch set by the host software. In some implementations, a DPA of an incoming access request (e.g., a CXL.mem request) may be passed by a CXL front-end 331 to an access parser 332, which may be a component of a CXL controller (e.g., an ASIC) that is configured to map memory addresses in a memory request to a unit ID and/or to pass the unit ID to one or more access trackers configured to track accesses to the unit ID. In that regard, the access parser 332 may align the DPA of the incoming request to a unit size configured by the host software (e.g., 2 MB in the example shown in FIG. 3D), and/or may pass the unit ID to the CBT access tracker 322. As shown in connection with the arrows entering and leaving the access parser 332, in some implementations the DPA may be a 64-bit bit string and/or the unit ID may be a 19-bit bit string (e.g., the unit ID may be composed of 19 of the 64 bits making up the DPA), which is described in more detail below.

The CBT access tracker 322, and more particularly a CBT manager 334 of the CBT access tracker 322, may decode the unit ID to identify the target set (e.g., a target one of the sets 324 described above in connection with FIG. 3C), with the remaining bits being used to identify the tag to identify the target cache line within the target set. The CBT manager 334 may search the tag memory 328 to determine if the tag is already in the tag memory 328 (e.g., to determine if a cache line in the cache 326 is already associated with the unit ID and/or to determine if a cache line in the cache already stores a counter associated with the unit ID). If the CBT manager 334 locates the tag in the tag memory 328 (sometimes referred to herein as a “hit”), a counter in a corresponding cache line may be updated (e.g., incremented). On the other hand, if the CBT manager 334 does not locate the tag in the tag memory 328 (sometimes referred to herein as a “miss”), a cache line in the corresponding set 324 may be evicted using a certain eviction policy (e.g., a FIFO policy, an LRU policy, or a random policy, among other examples) such that a counter associated with the tag may be added to the set 324 and set to one (indicating the first access during the given epoch). In this regard, the counter value previously stored at the cache line may be lost.

In some implementations, the CBT access tracker 322 may pass the unit ID and the associated counter value (e.g., the 16-bit counter described above in connection with FIG. 3C) to a hotness subsystem 335. The hotness subsystem 335, and more particularly a hotness evaluator 336 of the hotness subsystem 335, may compare the counter value against a hotness threshold set by the host. If the counter value satisfies the threshold, the unit ID and/or associated counter value may be registered in a hotlist 337 (sometimes referred to as an HN-L, because the hotlist may be configured to track the hottest N unit IDs for a given epoch), which is described in more detail in connection with FIG. 3F. Put another way, when a given counter satisfies a hotness threshold programmed by the host software during a given epoch, the corresponding memory unit may be classified as hot, and thus the corresponding unit ID may be added to hotlist 337.

Reference number 338 shows one example of how a DPA may be decoded by the access parser 332 and/or the CBT manager 334 to determine a unit ID, a tag, and/or a set index. In the example indicated by reference number 338, the DPA may be a 64-bit bit string used to identify a particular location within a 1 TB memory device. Additionally, or alternatively, the unit size to be used for the CBT access tracker 322 may be 2 MB (which, in some implementations, may be configured by the host software). In such examples, a first set of bits associated with the DPA may be inapplicable to the CBT access tracker 322, because the first set of bits may be associated with memory locations at a more granular level than the unit size (e.g., 2 MB in this example). More particularly, as indicated by reference number 339, the first 21 bits (e.g., the bits indexed 0 through 20) may indicate memory locations at a finer granularity than 2 MB, and thus may be irrelevant for the CBT access tracker 322. As indicated by reference number 340, a next set of bits of the DPA may correspond to the unit ID. For example, in some implementations the unit ID may be a 19-bit bit string, which may correspond to bits indexed as 21 through 39 of the DPA.

Moreover, a first subset of the bits forming the unit ID may correspond to the tag, and a second subset of the bits forming the unit ID may correspond to the set index. More particularly, as indicated by reference number 341, the last five bits of the unit ID (e.g., bits indexed as 35 through 39 of the DPA) may correspond to the tag and, as indicated by reference number 342, the first fourteen bits of the unit ID (e.g., bits indexed as 21 through 34 of the DPA) may correspond to the set index. Accordingly, upon receiving the DPA from the CXL front-end 331, the access parser 332 may identify that the DPA is associated with a memory address range to be tracked by the CBT access tracker 322, and may thus parse the unit ID therefrom (e.g., bits 21-39) and pass the unit ID to the CBT access tracker 322. The CBT access tracker 322 (more particularly, the CBT manager 334 of the CBT access tracker 322) may identify the set index (e.g., the first fourteen bits of the unit ID) and the tag (e.g., the last five bits of the unit ID) associated with the memory request, and may search the portion of the tag memory 328 associated with the corresponding set to determine if a cache line corresponds to the unit ID. In the case of a hit, the CBT manager 334 may update (e.g., increment) the counter stored at the cache line, as described above. And in the case of a miss, the CBT manager 334 may evict another cache line (e.g., using a FIFO policy, an LRU policy, a random policy, and/or another policy) to replace the counter with a counter (which may be set to one) corresponding to the instant memory request and/or unit ID, as described above. The CBT manager 334 may also update the tag memory 328 to include the tag of the instant memory request and/or unit ID, such that the counter may be updated later in the epoch, if the memory unit is subsequently accessed during the epoch.

FIG. 3E shows an example of an SLT access tracker 344 (sometimes referred to herein as an SLT based CHMU in the context of a CXL memory, such as in the context of the CXL device 304), as another example of an access tracker that may be configured at a memory device for tracking accesses to portions of memory. In some implementations, an SLT may be a table addressed by a unit ID that is derived from the address of the memory request (e.g., the CXL.mem request). As indicated by reference number 346, in some implementations each entry in the table stores a counter related to the unit ID. For example, each entry in the table of the SLT access tracker 344 may store a 32-bit counter associated with each unit ID. In this regard, for each access to a given unit ID, the corresponding counter may be updated (e.g., incremented), and when a counter satisfies a hotness threshold (e.g., a hotness threshold programmed by the host software), the unit may be classified as hot and/or the unit ID and associated counter value may be added to a hotlist (e.g., an HN-L), which is described in more detail below in connection with FIG. 3F.

In some implementations, the SLT access tracker 344 may be configured to track accesses at a relatively coarse granularity (e.g., with a relatively large unit size) and/or may be configured to track accesses across an entire device capacity. For example, as indicated by reference number 348, a capacity of a memory device (e.g., CXL device 204) may be 1 TB, and the SLT access tracker 344 may be configured to track accesses across an entire device capacity at a 1 GB granularity (e.g., using a 1 GB unit size). In such implementations, the SLT may include 1,024 entries, corresponding to 1,024 memory units to be tracked during the epoch (indexed in FIG. 3E as unit ID 0 through unit ID 1023).

FIG. 3F is a diagram of an example implementation associated with memory access tracking using multiple access trackers. As shown in FIG. 3F, the example implementation includes an access parser system 350, a tracking system 352, and/or a hotlist subsystem 354 (which, in some implementations, corresponds to the hotness subsystem 335). In some implementations, the access parser system 350 may include the access parser 332 described above in connection with FIG. 3D. Additionally, or alternatively, the tracking system 352 may include the CBF access tracker 314 (e.g., a CBF based CHMU) described above in connection with FIG. 3B, the CBT access tracker 322 (e.g., the CBT based CHMU) described above in connection with FIGS. 3C and 3D, and/or the SLT access tracker 344 (e.g., the SLT based CHMU) described above in connection with FIG. 3E. Additionally, or alternatively, the hotlist subsystem 354 may include the hotness evaluator 336 described above in connection with FIG. 3D. In some implementations, one or more components of the access parser system 350, the tracking system 352, and/or the hotlist subsystem 354 may be components of a memory controller, such as components of a CXL controller. For example, one or more components of the access parser system 350, the tracking system 352, and/or the hotlist subsystem 354 may be components of an ASIC of the CXL device 204 and/or the CXL device 304.

In some implementations, a memory device (e.g., CXL device 304) may receive, from a host device (e.g., CXL host 302), configuration information indicating a set of configuration parameters for each access tracker, of the multiple access trackers associated with the memory device. For example, in memory tiering applications supported by the CXL multi-hotness tracker solution, each tracker (e.g., the CBT access tracker 322, the CBF access tracker 314, or the SLT access tracker 344) may have different configurations depending on the unit size, epoch duration, and/or hotness threshold required by different system workloads. Accordingly, the host software (e.g., software at the CXL host 302) may activate access trackers (e.g., hotness trackers) and/or CHMUs (e.g., in the example in which the memory device is the CXL device 304) exposed by the memory device (e.g., the CXL device 304) in non-overlapping or overlapping memory ranges, setting different parameters (e.g., via one or more registers) for each access tracker and/or CHMU.

For example, in implementations in which the memory device is the CXL device 304 having a 1 TB capacity and configured to track accesses using multiple CHMUs 308 (as described above in connection with FIG. 3A), the host software may activate a first CHMU (sometimes referred to in the context of FIG. 3F as CHMU0, which may correspond to the SLT access tracker 344) for an address range of 0 GB to 511 GB, with a unit size of 1 GB and a hotness threshold of 2¹⁶ accesses. Additionally, or alternatively, the host software may activate a second CHMU (sometimes referred to in the context of FIG. 3F as CHMU1, which may correspond to the CBT access tracker 322) for an address range of 512 GB to 1007 GB, with a unit size of 2 MB and a hotness threshold of 2⁹ accesses. Additionally, or alternatively, the host software may activate a third CHMU (sometimes referred to in the context of FIG. 3F as CHMU2, which may correspond to the CBF access tracker 314) for an address range of 1008 GB to 1023 GB, with a unit size of 4 kB and a hotness threshold of 2⁴ accesses, among other examples.

In some examples, based on the configuration parameters, the memory device may configure the multiple access trackers, whose characteristics may be abstracted to the host software. For example, the memory device may configure the SLT access tracker 344 to be used to track accesses associated with CHMU0, the memory device may configure the CBT access tracker 322 to be used to track accesses associated with CHMU1, and/or the memory device may configure the CBF access tracker 314 to be used to track accesses associated with CHMU2, among other examples. In that regard, a first memory unit size associated with the CBF access tracker 314 (e.g., 4 KB in the above example) may differ from a second memory unit size associated with the CBT access tracker 322 (e.g., 2 MB in the above example) and a third memory unit size associated with the SLT access tracker 344 (e.g., 1 GB in the above example), and the second memory unit size associated with the CBT access tracker 322 (e.g., 2 MB) may in turn differ from the third memory unit size associated with the SLT access tracker 344 (e.g., 1 GB). More generally, the multiple access trackers of the tracking system 352 may be configured with different unit sizes (e.g., 4 kB, 512 KB, 1 MB, 2 MB, or 1 GB, among other examples) reflecting the granularity required for monitoring by the host.

As shown by reference number 356, the memory device (more particularly, the access parser 332 of the memory device) may receive, from the host device, an access request (e.g., a CXL.mem request) indicating a memory address (e.g., a DPA) associated with a portion of a memory (e.g., memory 306) that is to be accessed. For example, the memory device may be part of a CXL ecosystem and receive requests from a host for accessing specific portions of a memory, which is segmented into various ranges for tracking purposes as per the system's configuration, as described above in context with the CHMU0, CHMU1, and CHMU2.

As shown by reference number 358, the memory device (e.g., the access parser 332 of the memory device) may determine one or more unit IDs associated with the memory address (e.g., the DPA). For example, the address provided in the access request may be analyzed and aligned according to the unit size to derive the respective unit ID(s) that correspond to memory to system (M2S) requests, which are then used by the tracking system 352 (e.g., the access trackers of the tracking system 352). Put another way, in the context of a CXL memory, the DPA of the CXL.mem request may be converted into one or more unit IDs (e.g., a single unit ID in a case in which the access trackers are associated with non-overlapping address ranges, or one or multiple unit IDs in a case in which the access trackers are associated with overlapping address ranges), and the one or more unit IDs may be routed to the access tracker(s) assigned to the address range that the DPA falls into. That is, the memory device (e.g., the access parser 332 of the memory device) may identify one or more access trackers, of the multiple access trackers, that are associated with the one or more unit IDs, and may route the one or more unit IDs to the identified one or more access trackers.

For example, based on the derived unit ID(s), the memory device may ascertain which of the available tracking mechanisms (e.g., the CBT access tracker 322, the CBF access tracker 314, and/or the SLT access tracker 344) should handle the request based on the predefined memory ranges assigned to each tracker, as well as the ability to configure multiple hotness trackers with different parameters for each tracker. More particularly, returning to the example above involving CHMU0, CHMU1, and CHMU2, the access parser 332 may route a corresponding unit ID to the SLT access tracker 344 (e.g., CHMU0) when the DPA falls within an address range of 0 GB to 511 GB, the access parser 332 may route a corresponding unit ID to the CBT access tracker 322 (e.g., CHMU1) when the DPA falls within an address range of 512 GB to 1007 GB, and/or the access parser 332 may route a corresponding unit ID to the CBF access tracker 314 (e.g., CHMU2) when the DPA falls within an address range of 1008 GB to 1023 GB.

As shown by reference number 360, the memory device may update the one or more access trackers (e.g., increment one or more counters associated with the one or more access trackers). For example, based on the identified access tracker and the corresponding unit identifier, an associated counter (e.g., a counter in the CBT access tracker 322, the CBF access tracker 314, and/or the SLT access tracker 344) may be incremented in a similar manner as described above in connection with FIGS. 3B-3E, which may aid in the hotness tracking of various memory segments.

As shown by reference number 362, the tracking system 352 may forward the one or more unit IDs and corresponding one or more counters (shown in FIG. 3F as “cnt”) to the hotlist subsystem 354 (more particularly, the hotness evaluator 336 of the hotlist subsystem 354), such as for a purpose of determining whether the corresponding memory unit has become hot (e.g., to determine whether the counter satisfies a hotness threshold set by the host software). Put another way, in some implementations, unit ID and counter pairs may be sent by the tracking system 352 to the hotlist subsystem 354 such that the hotness evaluator 336 can check if the counter value satisfies a hotness threshold associated to each CHMU. In this regard, the memory device (e.g., the hotness evaluator 336 of the memory device) may determine that an access counter associated with a unit ID satisfies an access threshold (e.g., a hotness threshold). As shown by reference number 364, if a certain counter value does satisfy a respective hotness threshold, the hotness evaluator 336 may add the unit ID and the counter value to a respective hotlist (e.g., a respective HN-L).

As shown in connection with hotlist subsystem 354, in some implementations the memory device may be associated with multiple hotlists (e.g., multiple HN-Ls), such as one hotlist for each access tracker. Put another way, different hotlists may be associated with each access tracker, facilitating separate tracking of hotness based on unique configurations applied to different memory segments. For example, returning to the example above involving CHMU0, CHMU1, and CHMU2, the hotlist subsystem 354 may maintain a first hotlist (shown in FIG. 3F as Hotlist 0) for CHMU0 and/or that is associated with a hotness threshold of 2¹⁶, the hotlist subsystem 354 may maintain a second hotlist (shown in FIG. 3F as Hotlist 1) for CHMU1 and/or that is associated with a hotness threshold of 2⁹, and/or the hotlist subsystem 354 may maintain a third hotlist (shown in FIG. 3F as Hotlist 2) for CHMU2 and/or that is associated with a hotness threshold of 2⁴, among other examples. In such examples, once a unit's access frequency exceeds the set threshold, the hot unit may be added to one of these hotlists (e.g., one of Hotlist 0, Hotlist 1, or Hotlist 2), which may be a collection mechanism within the hotlist subsystem 354 for hot units.

As indicated above, FIGS. 3A-3F are provided as an example. Other examples may differ from what is described with regard to FIGS. 3A-3F. The number and arrangement of devices shown in FIGS. 3A-3F are provided as an example. In practice, there may be additional devices, fewer devices, different devices, or differently arranged devices than those shown in FIGS. 3A-3F. Furthermore, two or more devices shown in FIGS. 3A-3F may be implemented within a single device (e.g., an ASIC of a CXL controller), or a single device shown in FIGS. 3A-3F may be implemented as multiple, distributed devices. Additionally, or alternatively, a set of devices (e.g., one or more devices) shown in FIGS. 3A-3F may perform one or more functions described as being performed by another set of devices shown in FIGS. 3A-3F.

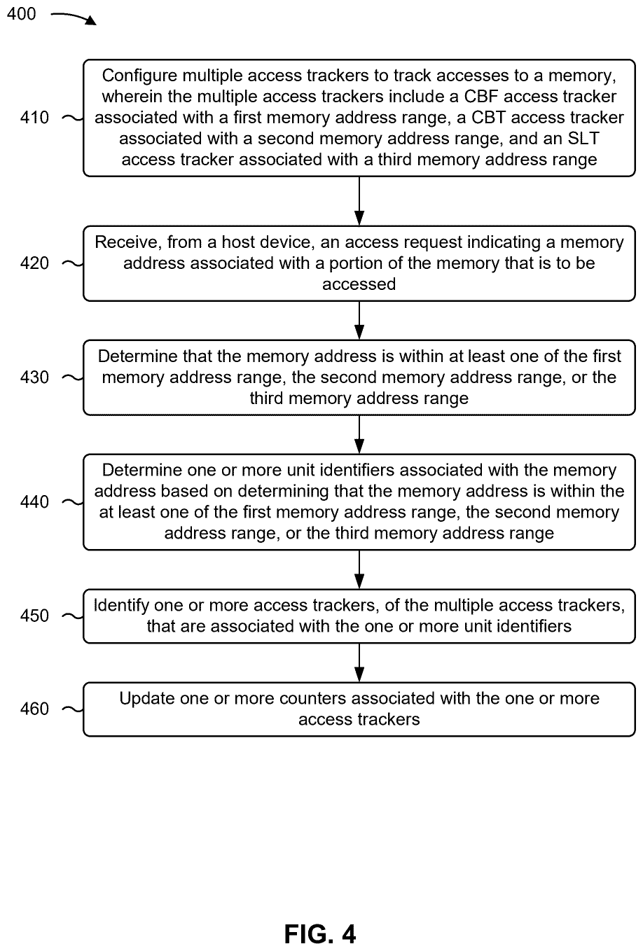

FIG. 4 is a flowchart of an example method 400 associated with multiple access trackers for a memory device. In some implementations, a memory system and/or a memory device (e.g., the memory system 110, the memory device 120, the CXL device 204, and/or the CXL device 304) may perform or may be configured to perform the method 400. In some implementations, another device or a group of devices separate from or including the memory system and/or the memory device (e.g., the system 100, the system 200, and/or the system 300) may perform or may be configured to perform the method 400. Additionally, or alternatively, one or more components of the memory system and/or the memory device (e.g., the memory system controller 115, the local controller 125, the main management subsystem 214, one or more CHMUs 308, the access parser 332, the hotness evaluator 336, the access parser system 350, the tracking system 352, and/or the hotlist subsystem 354) may perform or may be configured to perform the method 400. Thus, means for performing the method 400 may include the memory system and/or the memory device, and/or one or more components of the memory system and/or the memory device. Additionally, or alternatively, a non-transitory computer-readable medium may store one or more instructions that, when executed by the memory system and/or the memory device (e.g., the memory system controller 115 of the memory system 110, the local controller 125 of the memory device 120, and/or the main management subsystem 214 of the CXL device 204), cause the memory system and/or the memory device to perform the method 400.

As shown in FIG. 4, the method 400 may include configuring multiple access trackers to track accesses to a memory, wherein the multiple access trackers include a CBF access tracker associated with a first memory address range, a CBT access tracker associated with a second memory address range, and an SLT access tracker associated with a third memory address range (block 410). For example, the CXL device 304 may configure the multiple access trackers and/or the multiple CHMUs 308 described above in connection with FIGS. 3A-3E, such as the CBF access tracker 314 and/or a CBF based CHMU, the CBT access tracker 322 and/or a CBT based CHMU, and/or the SLT access tracker 344 and/or an SLT based CHMU.

As further shown in FIG. 4, the method 400 may include receiving, from a host device, an access request indicating a memory address associated with a portion of the memory that is to be accessed (block 420). For example, the CXL device 304 may receive, from the CXL host 302, a CXL.mem request indicating a DPA associated with a portion of the memory 306 that is to be accessed, as described above in connection with FIGS. 3D and 3F.

As further shown in FIG. 4, the method 400 may include determining that the memory address is within at least one of the first memory address range, the second memory address range, or the third memory address range (block 430). For example, the access parser 332 of the CXL device 304 may determine that the DPA is within a memory address range to be tracked by the CBF access tracker 314, a memory address range to be tracked by the CBT access tracker 322, and/or a memory address range to be tracked by the SLT access tracker 344, as described above in connection with FIG. 3F. Moreover, in some implementations, the memory address range to be tracked by the CBF access tracker 314, the memory address range to be tracked by the CBT access tracker 322, and the memory address range to be tracked by the SLT access tracker 344 may be different memory address ranges. In some other implementations, at least two of the memory address range to be tracked by the CBF access tracker 314, the memory address range to be tracked by the CBT access tracker 322, or the memory address range to be tracked by the SLT access tracker 344 may at least partially overlap. Additionally, or alternatively, in some other implementations, at least two of the memory address range to be tracked by the CBF access tracker 314, the memory address range to be tracked by the CBT access tracker 322, or the memory address range to be tracked by the SLT access tracker 344 may be the same address range that is tracked by two or more of the CBF access tracker 314, the CBT access tracker 314, or the SLT access tracker 344 using different granularities.

As further shown in FIG. 4, the method 400 may include determining one or more unit identifiers associated with the memory address based on determining that the memory address is within the at least one of the first memory address range, the second memory address range, or the third memory address range (block 440). For example, the access parser 332 of the CXL device 304 may determine a unit ID corresponding to a 4 KB unit associated with the CBF access tracker 314, a unit ID corresponding to a 2 MB unit associated with the CBT access tracker 322, and/or a unit ID corresponding to a 1 GB unit associated with the SLT access tracker 344, as described above in connection with FIG. 3F.

As further shown in FIG. 4, the method 400 may include identifying one or more access trackers, of the multiple access trackers, that are associated with the one or more unit identifiers (block 450). For example, the access parser 332 of the CXL device 304 may identify that the CBF access tracker 314 is associated with a 4 kB unit ID corresponding to the memory request, that the CBT access tracker 322 is associated with a 2 MB unit ID corresponding to the memory request, and/or that the SLT access tracker 344 is associated with a 1 GB unit ID corresponding to the memory request, as described above in connection with FIG. 3F.

As further shown in FIG. 4, the method 400 may include updating one or more counters associated with the one or more access trackers (block 460). For example, in implementations in which the memory request is associated with a memory range tracked by the CBF access tracker 314, the CXL device 304 may update a counter associated with a corresponding unit ID by hashing the unit ID into multiple hash functions to derive indexes in the CBF where counters are incremented, as described in more detail above in connection with FIG. 3B. Additionally, or alternatively, in implementations in which the memory request is associated with a memory range tracked by the CBT access tracker 322, the CXL device 304 may update a counter associated with a corresponding unit ID by determining a set associated with the unit ID and/or incrementing a cache line associated with the unit ID, as described in more detail above in connection with FIGS. 3C and 3D. Additionally, or alternatively, in implementations in which the memory request is associated with a memory range tracked by the SLT access tracker 344, the CXL device 304 may update a counter associated with a corresponding unit ID by incrementing a counter stored at an entry in the SLT corresponding to the unit ID, as described above in more detail in connection with FIG. 3E.

The method 400 may include additional aspects, such as any single aspect or any combination of aspects described below and/or described in connection with one or more other methods or operations described elsewhere herein.

In a first aspect, the method 400 includes receiving, by the memory device from the host device, configuration information indicating a set of configuration parameters for each access tracker, of the multiple access trackers, wherein configuring the multiple access trackers to track accesses to the memory is based on the configuration information. For example, the CXL device 304 may receive, from the CXL host 202 (e.g., via one or more CHMU registers), configuration information setting various parameters for one or more CHMUs, such as an address range of 0 GB to 511 GB, a unit size of 1 GB, and/or a hotness threshold of 2¹⁶ accesses for CHMU0; an address range of 512 GB to 1007 GB, a unit size of 2 MB, and/or a hotness threshold of 2⁹ accesses for CHMU1; and/or an address range of 1008 GB to 1023 GB, a unit size of 4 KB, and/or a hotness threshold of 2⁴ accesses for CHMU2, as described above in connection with FIG. 3F.

In a second aspect, alone or in combination with the first aspect, at least one of the first memory address range, the second memory address range, or the third memory address range at least partially overlaps with another one of the first memory address range, the second memory address range, or the third memory address range. For example, in some implementations, the CXL host 302 may configure the CXL device 304 to monitor access to the memory 306 with multiple access trackers (e.g., multiple CHMUs) using overlapping memory ranges, as described above in connection with FIGS. 3A-3F.

In a third aspect, alone or in combination with one or more of the first and second aspects, the first memory address range does not overlap with either of the second memory address range or the third memory address range, and the second memory address range does not overlap with the third memory address range. For example, in some implementations, the CXL host 302 may configure the CXL device 304 to monitor access to the memory 306 with multiple access trackers (e.g., multiple CHMUs) using non-overlapping memory ranges, as described above in connection with FIGS. 3A-3F.

In a fourth aspect, alone or in combination with one or more of the first through third aspects, the memory is associated with multiple hotlists, a first hotlist, of the multiple hotlists, is associated with the CBF access tracker, a second hotlist, of the multiple hotlists, is associated with the CBT access tracker, and a third hotlist, of the multiple hotlists, is associated with the SLT access tracker. For example, the hotlist subsystem 354 of the CXL device 304 may include a first hotlist (e.g., Hotlist 0) corresponding to the CHMU0, a second hotlist (e.g., Hotlist 1) corresponding to the CHMU1, and/or a third hotlist (e.g., Hotlist 2) corresponding to the CHMU2, among other examples.

In a fifth aspect, alone or in combination with one or more of the first through fourth aspects, the method 400 includes determining, by the memory device, that a counter, of the one or more counters, associated with a unit identifier, of the one or more unit identifiers, satisfies an access threshold, and adding, by the memory device, the unit identifier to a hotlist based on determining that the counter associated with the unit identifier satisfies the access threshold. For example, the hotness evaluator 336 of the CXL device 304 may receive a unit ID and counter value pair from the tracking system 352, may determine that the counter value satisfies a corresponding hotness threshold, and/or may add the unit ID and the counter value pair to a corresponding hotlist (e.g., a corresponding HN-L), accordingly, as described above in connection with FIG. 3F.

In a sixth aspect, alone or in combination with one or more of the first through fifth aspects, a first unit size associated with the CBF access tracker differs from a second unit size associated with the CBT access tracker and a third unit size associated with the SLT access tracker, and the second unit size differs from the third unit size. For example, a first unit size associated with the CBF access tracker 314 and/or the CHMU2 may be 4 KB, a second unit size associated with the CBT access tracker 322 and/or the CHMU1 may be 2 MB, and/or a third unit size associated with the SLT access tracker 344 and/or the CHMU0 may be 1 GB, as described above in connection with FIG. 3F.

In a seventh aspect, alone or in combination with one or more of the first through sixth aspects, the one or more access trackers include the CBT access tracker, and determining the one or more unit identifiers associated with the memory address includes identifying a unit identifier associated with the CBT access tracker using at least one of multiple tag bits indicated by the memory address, or multiple set index bits indicated by the memory address. For example, the access parser 332 may derive the unit ID using bits indexed as 21 through 39 of the DPA, with bits indexed as 21 through 34 corresponding to a set index of the CBT access tracker 322 and/or with the bits indexed as 35 through 39 corresponding to a tag of the CBT access tracker 322, as described above in connection with FIG. 3D.

In an eighth aspect, alone or in combination with one or more of the first through seventh aspects, the one or more access trackers include the CBT access tracker, the one or more unit identifiers include a unit identifier associated with the CBT access tracker, and updating the one or more counters associated with the one or more access trackers includes updating a cache line associated with the CBT access tracker that corresponds to the unit identifier. For example, in a case in which a cache line in the cache 326 is already associated with the unit being accessed (e.g., as indicated by a tag in the tag memory 328), the CBT access tracker 322 may increment the 16-bit counter in the cache line, as described above in connection with FIGS. 3C and 3D.

In a ninth aspect, alone or in combination with one or more of the first through eighth aspects, the one or more access trackers include the CBT access tracker, the one or more unit identifiers include a unit identifier associated with the CBT access tracker, and updating the one or more counters associated with the one or more access trackers includes evicting a cache line associated with the CBT access tracker that corresponds to another unit identifier associated with the CBT access tracker. For example, in a case in which there is not already a cache line in the cache 326 that is associated with the unit being accessed, the CBT access tracker 322 may evict another cache line (e.g., using a FIFO policy, an LRU policy, a random policy, or another policy), and may set the 16-bit counter in the cache line to one, as described above in connection with FIGS. 3C and 3D.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

In some implementations, a memory device includes one or more components configured to: receive, from a host device, an access request indicating a memory address associated with a portion of a memory that is to be accessed, wherein the memory is associated with multiple access trackers including a counting bloom filter (CBF) access tracker, a cache-based tracker (CBT) access tracker, and a sorted look-up table (SLT) access tracker; determine one or more unit identifiers associated with the memory address; identify one or more access trackers, of the multiple access trackers, that are associated with the one or more unit identifiers; and update one or more counters associated with the one or more access trackers.

In some implementations, a method includes configuring, by a memory device, multiple access trackers to track accesses to a memory, wherein the multiple access trackers include a counting bloom filter (CBF) access tracker associated with a first memory address range, a cache-based tracker (CBT) access tracker associated with a second memory address range, and a sorted look-up table (SLT) access tracker associated with a third memory address range; receiving, by the memory device and from a host device, an access request indicating a memory address associated with a portion of the memory that is to be accessed; determining, by the memory device, that the memory address is within at least one of the first memory address range, the second memory address range, or the third memory address range; determining, by the memory device, one or more unit identifiers associated with the memory address based on determining that the memory address is within the at least one of the first memory address range, the second memory address range, or the third memory address range; identify, by the memory device, one or more access trackers, of the multiple access trackers, that are associated with the one or more unit identifiers; and updating, by the memory device, one or more counters associated with the one or more access trackers.

In some implementations, a compute express link (CXL) compliant memory device includes one or more components configured to: receive, from a host device, a CXL.memory request indicating a memory address associated with a portion of a dynamic random access memory (DRAM) that is to be accessed, wherein the DRAM is associated with multiple CXL hotness monitoring units (CHMUs) including a counting bloom filter (CBF) based CHMU, a cache-based tracker (CBT) based CHMU, and a sorted look-up table (SLT) based CHMU; determine one or more unit identifiers associated with the memory address; identify one or more CHMUs, of the multiple CHMUs, that are associated with the one or more unit identifiers; and update one or more counters associated with the one or more CHMUs.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
receive, from a host device, an access request indicating a memory address associated with a portion of a memory that is to be accessed,
wherein the memory is associated with multiple access trackers including a counting bloom filter (CBF) access tracker, a cache-based tracker (CBT) access tracker, and a sorted look-up table (SLT) access tracker;
determine one or more unit identifiers associated with the memory address;
identify one or more access trackers, of the multiple access trackers, that are associated with the one or more unit identifiers; and
update one or more counters associated with the one or more access trackers.

2. The memory device of claim 1, wherein the one or more components are further configured to receive, from the host device, configuration information indicating a set of configuration parameters for each access tracker, of the multiple access trackers.

3. The memory device of claim 1, wherein a first memory address range associated with one of the CBF access tracker, the CBT access tracker, or the SLT access tracker at least partially overlaps with a second memory address range associated with another one of the CBF access tracker, the CBT access tracker, or the SLT access tracker.

4. The memory device of claim 1, wherein a first memory address range associated with the CBF access tracker does not overlap with either of a second memory address range associated with the CBT access tracker or a third memory address range associated with the SLT access tracker, and
wherein the second memory address range does not overlap with the third memory address range.

5. The memory device of claim 1, wherein the memory is associated with multiple hotlists,
wherein a first hotlist, of the multiple hotlists, is associated with the CBF access tracker,
wherein a second hotlist, of the multiple hotlists, is associated with the CBT access tracker, and
wherein a third hotlist, of the multiple hotlists, is associated with the SLT access tracker.

6. The memory device of claim 1, wherein the one or more components are further configured to:
determine that a counter, of the one or more counters, associated with a unit identifier, of the one or more unit identifiers, satisfies an access threshold; and
add the unit identifier to a hotlist based on determining that the counter associated with the unit identifier satisfies the access threshold.

7. The memory device of claim 1, wherein a first unit size associated with the CBF access tracker differs from a second unit size associated with the CBT access tracker and a third unit size associated with the SLT access tracker, and
wherein the second unit size differs from the third unit size.

8. The memory device of claim 1, wherein the one or more access trackers include the CBT access tracker, and
wherein the one or more components, to determine the one or more unit identifiers associated with the memory address, are configured to identify a unit identifier associated with the CBT access tracker using at least one of:
multiple tag bits indicated by the memory address, or
multiple set index bits indicated by the memory address.

9. The memory device of claim 1, wherein the one or more access trackers include the CBT access tracker,
wherein the one or more unit identifiers include a unit identifier associated with the CBT access tracker, and
wherein the one or more components, to update the one or more counters associated with the one or more access trackers, are configured to update a cache line associated with the CBT access tracker that corresponds to the unit identifier.

10. The memory device of claim 1, wherein the one or more access trackers include the CBT access tracker,
wherein the one or more unit identifiers include a unit identifier associated with the CBT access tracker, and
wherein the one or more components, to update the one or more counters associated with the one or more access trackers, are configured to evict a cache line associated with the CBT access tracker that corresponds to another unit identifier associated with the CBT access tracker.

11. A method, comprising:
configuring, by a memory device, multiple access trackers to track accesses to a memory,
wherein the multiple access trackers include a counting bloom filter (CBF) access tracker associated with a first memory address range, a cache-based tracker (CBT) access tracker associated with a second memory address range, and a sorted look-up table (SLT) access tracker associated with a third memory address range;
receiving, by the memory device and from a host device, an access request indicating a memory address associated with a portion of the memory that is to be accessed;
determining, by the memory device, that the memory address is within at least one of the first memory address range, the second memory address range, or the third memory address range;
determining, by the memory device, one or more unit identifiers associated with the memory address based on determining that the memory address is within the at least one of the first memory address range, the second memory address range, or the third memory address range;
identify, by the memory device, one or more access trackers, of the multiple access trackers, that are associated with the one or more unit identifiers; and
updating, by the memory device, one or more counters associated with the one or more access trackers.

12. The method of claim 11, further comprising receiving, by the memory device from the host device, configuration information indicating a set of configuration parameters for each access tracker, of the multiple access trackers,
wherein configuring the multiple access trackers to track accesses to the memory is based on the configuration information.

13. The method of claim 11, wherein at least one of the first memory address range, the second memory address range, or the third memory address range at least partially overlaps with another one of the first memory address range, the second memory address range, or the third memory address range.

14. The method of claim 11, wherein the first memory address range does not overlap with either of the second memory address range or the third memory address range, and
wherein the second memory address range does not overlap with the third memory address range.

15. The method of claim 11, wherein the memory is associated with multiple hotlists,
wherein a first hotlist, of the multiple hotlists, is associated with the CBF access tracker,
wherein a second hotlist, of the multiple hotlists, is associated with the CBT access tracker, and
wherein a third hotlist, of the multiple hotlists, is associated with the SLT access tracker.

16. The method of claim 11, further comprising:
determining, by the memory device, that a counter, of the one or more counters, associated with a unit identifier, of the one or more unit identifiers, satisfies an access threshold; and
adding, by the memory device, the unit identifier to a hotlist based on determining that the counter associated with the unit identifier satisfies the access threshold.

17. The method of claim 11, wherein a first unit size associated with the CBF access tracker differs from a second unit size associated with the CBT access tracker and a third unit size associated with the SLT access tracker, and
wherein the second unit size differs from the third unit size.

18. The method of claim 11, wherein the one or more access trackers include the CBT access tracker, and
wherein determining the one or more unit identifiers associated with the memory address includes identifying a unit identifier associated with the CBT access tracker using at least one of:
multiple tag bits indicated by the memory address, or
multiple set index bits indicated by the memory address.

19. The method of claim 11, wherein the one or more access trackers include the CBT access tracker,
wherein the one or more unit identifiers include a unit identifier associated with the CBT access tracker, and
wherein updating the one or more counters associated with the one or more access trackers include updating a cache line associated with the CBT access tracker that corresponds to the unit identifier.

20. The method of claim 11, wherein the one or more access trackers include the CBT access tracker,
wherein the one or more unit identifiers include a unit identifier associated with the CBT access tracker, and
wherein updating the one or more counters associated with the one or more access trackers includes evicting a cache line associated with the CBT access tracker that corresponds to another unit identifier associated with the CBT access tracker.

21. A compute express link (CXL) compliant memory device, comprising:
one or more components configured to:
receive, from a host device, a CXL.memory request indicating a memory address associated with a portion of a dynamic random access memory (DRAM) that is to be accessed,
wherein the DRAM is associated with multiple CXL hotness monitoring units (CHMUs) including a counting bloom filter (CBF) based CHMU, a cache-based tracker (CBT) based CHMU, and a sorted look-up table (SLT) based CHMU;
determine one or more unit identifiers associated with the memory address;
identify one or more CHMUs, of the multiple CHMUs, that are associated with the one or more unit identifiers; and
update one or more counters associated with the one or more CHMUs.

22. The CXL compliant memory device of claim 21, wherein the one or more components are further configured to receive, from the host device, configuration information indicating a set of configuration parameters for each CHMU, of the multiple CHMUs.

23. The CXL compliant memory device of claim 21, wherein the DRAM is associated with multiple hotlists,
wherein a first hotlist, of the multiple hotlists, is associated with the CBF based CHMU,
wherein a second hotlist, of the multiple hotlists, is associated with the CBT based CHMU, and
wherein a third hotlist, of the multiple hotlists, is associated with the SLT based CHMU.

24. The CXL compliant memory device of claim 21, wherein a first unit size associated with the CBF based CHMU differs from a second unit size associated with the CBT based CHMU and a third unit size associated with the SLT based CHMU, and
wherein the second unit size differs from the third unit size.

25. The CXL compliant memory device of claim 21, wherein the one or more CHMUs include the CBT based CHMU,
wherein the one or more unit identifiers include a unit identifier associated with the CBT based CHMU, and
wherein the one or more components, to update the one or more counters associated with the one or more CHMUs, are configured to at least one of:
update a first cache line associated with the CBT based CHMU that corresponds to the unit identifier, or
evict a second cache line associated with the CBT based CHMU that corresponds to another unit identifier associated with the CBT based CHMU.
